(19) United States
(12) Patent Application Publication
(10) Pub. No.: US 2007/0055991 A1
(43) Pub. Date: Mar. 8, 2007

(54) Electronic program guide apparatus and method in digital broadcasting system

(75) Inventors: Joon-Young Choi, Suwon-si (KR); Young-Soo Park, Yongin-si (KR); Jun-Young Jung, Yongin-si (KR); Geun-Ho Lee, Suwon-si (KR); Young-Ho Kim, Suwon-si (KR); Jae-Gwa Lee, Seoul (KR); Dong-Seek Park, Yongin-si (KR); Young-Kwon Cho, Suwon-si (KR); Jin-Kyu Koo, Suwon-si (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/516,556

(22) Filed: Sep. 7, 2006

(30) Foreign Application Priority Data
Sep. 7, 2005 (KR) 2005-0083093

(51) Int. Cl. H04N 5/445; G06F 13/00; G06F 3/00

(52) U.S. Cl. 725/40; 725/39; 725/41; 725/43

(57) ABSTRACT

An apparatus and method for providing EPG in a digital broadcasting system, in which an EPG connecting unit connects EPG servers of digital broadcasting channels, a program information generating unit generates program information according to program characteristics of the digital broadcasting channels, and an EPG server generates EPG information using the generated program information, and combines the generated EPG information with EPG information of the broadcasting channels. Accordingly, the program information of different broadcasting channels can be searched without switching channels, and quality of the EPG service can be improved. Moreover, users can be allowed to personally configure the EPG, thereby providing the EPG according to characteristics of the users.

### CROSS-REFERENCE TO RELATED PATENT APPLICATIONS

This application claims the benefit under 35 U.S.C. § 119(a) of a Korean Patent Application filed in the Korean Intellectual Property Office on Sep. 7, 2005 and allocated Serial No. 2005-83093, the entire disclosure of which is hereby incorporated by reference.

### BACKGROUND OF THE INVENTION

1. Field of the Invention

The present invention relates generally to an electronic program guide (EPG) in digital broadcasting. More particularly, the present invention relates to an apparatus and method for providing custom EPG according to characteristics of subscribers by adding additional functions (for example, thumbnail information and regional information) to the EPG in a digital broadcasting system.

1. Description of the Related Art

EPG is a program guide service that uses empty frequency bands between broadcasting signals in the multimedia and multichannel environment in which hundreds of channel information are provided through various media such as ground wave or satellite. That is, a program transmitting station such as a broadcasting station provides information about scheduled programs, allowing a user to easily select a desired program.

FIG. 1 is a schematic view illustrating the configuration of a general digital broadcasting system.

Referring to FIG. 1, the digital broadcasting system transmits programs of broadcasters 101, 103 and 105 to a data transmission center 107 over frequency channels allocated to the broadcasters 101, 103 and 105.

The data transmission center 107 compresses and modulates the programs provided from the broadcasters 101, 103 and 105 and transmits the programs to each user 109.

The digital broadcasting system provides an EPG service as illustrated in FIG. 2.

FIG. 2 illustrates an EPG screen of a conventional digital broadcasting system. In FIG. 2, a horizontal axis represents time (for example, units of 30 minutes) and a vertical axis represents channel.

Referring to FIG. 2, the EPG displays program information 201 of each channel. The EPG extracts related broadcasting program information according to a keyword 203 selected by the user, allowing the user to easily search a desired program.

To reduce the generation cost of the EPG, advertisement messages may be contained in the EPG. That is, the EPG can further include an advertisement window 205 to display advertisement message.

As described above, the EPG transmits the program information desired by the user over the empty frequency bands between the broadcasting signals, or transmits the advertisement message by using the advertisement window. However, the EPG merely provides the introduction of the programs, but does not provide additional information (for example, regional information, weather, shopping, moving picture, and the like).

In addition, because the broadcasters use different broadcasting channels, the user has to switch a current channel to other channels when he or she wants to search programs of other broadcasting channels.

Accordingly, there is a need for an improved electronic program guide apparatus and method that provides an introduction of programs and additional information, and allow users to search program information of different broadcasting channels without switching channels.

### SUMMARY OF THE INVENTION

An aspect of exemplary embodiments of the present invention is to address at least the above problems and/or disadvantages and to provide at least the advantages described below. Accordingly, an aspect of exemplary embodiments of the present invention is to provide an apparatus and method for providing EPG in a digital broadcasting system according to characteristics of users.

Another aspect of the present invention is to provide an apparatus and method for providing EPG according to characteristics of users by providing various search conditions in a digital broadcasting system.

A further aspect of the present invention is to provide an apparatus and method for providing EPG containing regional information in a digital broadcasting system.

A further aspect of the present invention is to provide an apparatus and method for providing EPG containing program information of other broadcasting channels in a digital broadcasting system.

According to one aspect of exemplary embodiments of the present invention, an apparatus for providing EPG in a digital broadcasting system includes an EPG connecting unit for connecting EPG servers of digital broadcasting channels; a program information generating unit for generating program information according to program characteristics of the digital broadcasting channels; and an EPG server for generating EPG information using the generated program information, and combining the generated EPG information with EPG information of the broadcasting channels.

According to another aspect of exemplary embodiments of the present invention, a method for generating combined EPG information in a digital broadcasting system, in which EPG information of self-channel that is generated by using program information of the self-channel; whether EPG information of a different channel is received is verified; and when the EPG information of the different channel is received, the EPG information of the self-channel with the EPG information of the different channel is combined.

According to a further aspect of exemplary embodiments of the present invention, a method for generating personal EPG in a digital broadcasting system, in which whether EPG search condition is inputted in an EPG search mode is checked; when the EPG search condition is inputted, the search condition from a combined EPG information is searched; the number of the search results is verified; and when the number of the search results is equal to or more than two, the personal EPG is generated.

According to a further aspect of exemplary embodiments of the present invention, a method for operating a base station (gap filler) to provide regional information by using an EPG service in a digital broadcasting system, in which when an EPG request is received from a terminal, EPG to a broadcasting data transmission center is requested; whether the requested EPG information is received is verified; and when the requested EPG information is received, the EPG information with the regional information is combined.

According to a further aspect of exemplary embodiments of the present invention, a method for providing regional information by using an EPG service in a digital broadcasting system, in which the regional information from a regional information provider is transmitted to a base station, and an EPG request message is transmitted from a terminal to the base station; the EPG from the base station is requested to a broadcasting data transmission center according to the EPG request; the EPG information from the broadcasting data transmission center is transmitted to the base station according to the EPG request; and the EPG information is received and the EPG is combined with the regional information at the base station, and the combined EPG is transmitted to the terminal.

### BRIEF DESCRIPTION OF THE DRAWINGS

The above and other objects, features and advantages of certain exemplary embodiments of the present invention will be more apparent from the following detailed description taken in conjunction with the accompanying drawings in which:

FIG. 1 is a schematic view illustrating the configuration of a general digital broadcasting system;

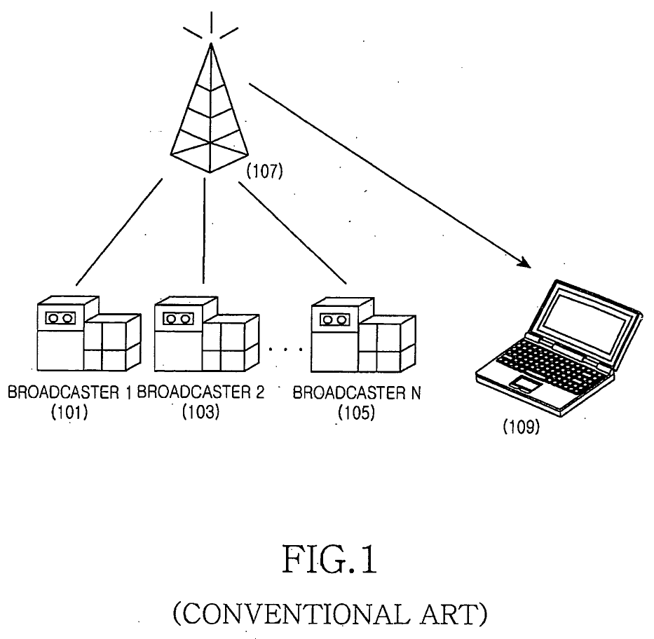

FIG. 2 illustrates an EPG screen of a conventional digital broadcasting system;

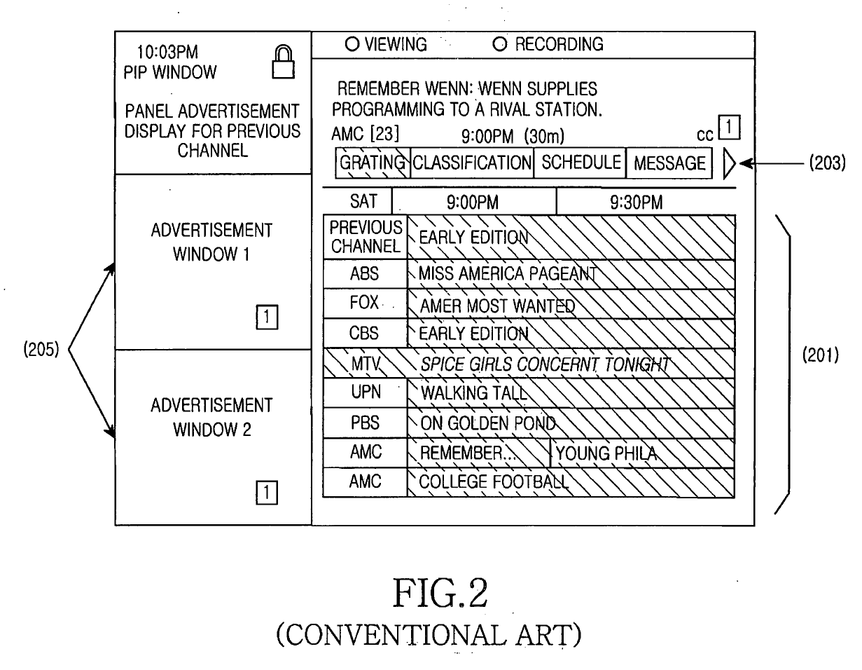

FIG. 3 is a block diagram of an EPG transmitter according to an exemplary embodiment of the present invention;

FIG. 4 is a flowchart illustrating a method for generating a combined EPG according to an exemplary embodiment of the present invention;

FIG. 5 is a flowchart illustrating a method for searching an EPG according to an exemplary embodiment of the present invention;

FIG. 6 is a flowchart illustrating a method for providing regional information using an EPG at a base station (gap filler) according to an exemplary embodiment of the present invention;

FIG. 7 is a flowchart illustrating a method for providing regional information using an EPG according to an exemplary embodiment of the present invention; and

FIG. 8 illustrates a personal EPG screen according to an exemplary embodiment of the present invention.

Throughout the drawings, the same drawing reference numerals will be understood to refer to the same elements, features and structures.

### DETAILED DESCRIPTION OF EXEMPLARY EMBODIMENTS

The matters defined in the description such as a detailed construction and elements are provided to assist in a comprehensive understanding of exemplary embodiments of the invention. Accordingly, those of ordinary skill in the art will recognize that various changes and modifications of the embodiments described herein can be made without departing from the scope and spirit of the invention. Also, descriptions of well-known functions and constructions are omitted for clarity and conciseness.

The following describes an apparatus and method for providing custom EPG according to characteristics of subscribers in a digital broadcasting system, in which new additional functions are added to the EPG.

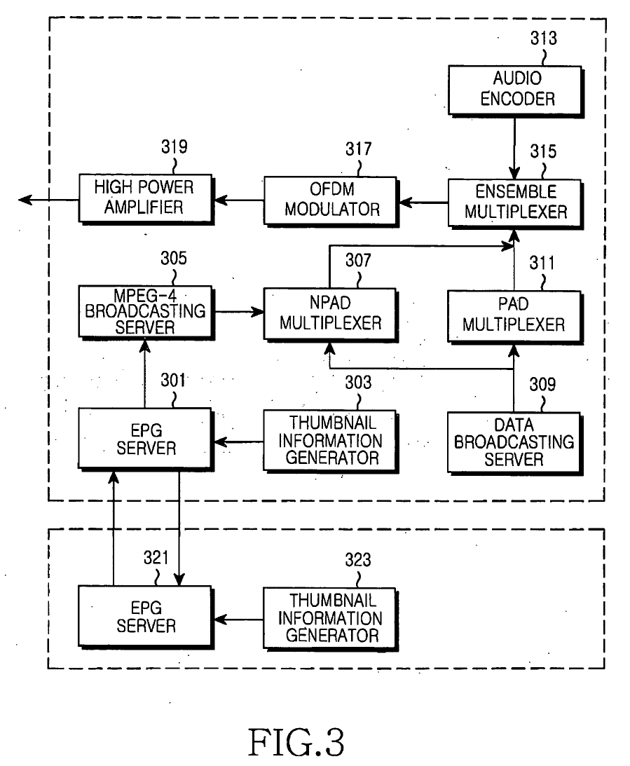

FIG. 3 is a block diagram of an EPG transmitter according to an exemplary embodiment of the present invention.

Referring to FIG. 3, the EPG transmitter includes EPG servers 301 and 321, thumbnail information generators 303 and 323, a Moving Picture Experts Group (MPEG)-4 broadcasting server 305, a Non Program Associated Data (NPAD) multiplexer 307, a data broadcasting server 309, a Program Associated Data (PAD) multiplexer 311, an audio encoder 313, an ensemble multiplexer 315, an Orthogonal Frequency Division Multiplexing (OFDM) modulator 317, and a high power amplifier 319.

The thumbnail information generators 303 and 323 generate low-capacity thumbnail information for introducing programs in a simple text or according to their characteristics. For example, the thumbnail information introduces news in a form of text, movies in a form of a preview moving picture or key moving picture, and a documentary in a form of an image.

In addition, service operators can make profit by inserting advertisements into the thumbnail information in a form of a simple moving picture or image.

The EPG server 301 generates EPG information of self-channel by using the thumbnail information provided from the thumbnail information generator 303. Furthermore, in order to distinguish the EPG information from another channel's EPG information, the EPG server 301 assigns an identifier to the EPG information and transmits the identifier to the EPG server 321 of another channel's transmitter through a private line connected thereto. An EPG connecting unit (not shown) is for connecting EPG server of another digital broadcasting channel. The EPG connecting unit is in the EPG server (301) or not. When EPG connecting unit receives the EPG information of another channel from the EPG server 321 of another channel's transmitter through the private line, the EPG server 301 combines the EPG information of other channels with the EPG information of self-channel and generates a transport stream (TS). At this point, the combined EPG may contain EPG information of all channels just like satellite digital multimedia broadcasting (DMB), or may contain EPG information of some channels under contract among some of terrestrial DMB operators that generate individual EPGs.

Because capacity of the EPG is small, the EPGs containing the thumbnail information of the respective broadcasting channels may not all be transmitted. In this case, the EPG can be created using the thumbnail information of the program that is being currently broadcast, or personal EPG previously set by the user can be transmitted. Furthermore, the thumbnail information of the channels that is being currently broadcast can be transmitted over data channels and be connected to the EPG using an identifier (ID) contained in each thumbnail information. In this manner, the capacity problem of the EPG can be solved.

Using MPEG-4 technology, the MPEG-4 broadcasting server 305 compresses the TS in which the EPG information of all channels provided from the EPG server 301 is combined. The NPAD multiplexer 307 multiplexes the TS containing the EPG provided from the MPEG-4 broadcasting server 305 and the non-programmed data provided from the data broadcasting server 309 to transmit the EPG information as independent data.

The data broadcasting server 309 transmits data for the data broadcasting service such as Transport Protocol Experts Group (TPEG) or Multimedia Object Transfer (MOT) to the NPAD multiplexer 307 or the PAD multiplexer 311 according to the data format. The TPEG is a protocol for transferring traffic and travel information. The PAD multiplexer 311 receives the programmed data from the data broadcasting server 309 and multiplexes the received programmed data.

The ensemble multiplexer 315 receives audio data encoded by the audio encoder 313 and multiplexes the encoded audio data together with the data provided from the NPAD multiplexer 307 and the PAD multiplexer 311.

The OFDM modulator 317 inverse fast Fourier transform (IFFT)-processes the final digital broadcasting data provided from the ensemble multiplexer 315 and converts the IFFT-processed digital broadcasting data into time-domain signals. The high power amplifier 319 amplifies power of the IFFT-processed digital broadcasting data.

As describe above, the EPG server 301 generates the TS by combining the EPG information of other channels as well as the EPG information of self-channel including the thumbnail information. Because the outgoing digital broadcasting data contains the EPG information of other channels, the user checks the program information of other channels, while viewing the broadcasting of the specific channel.

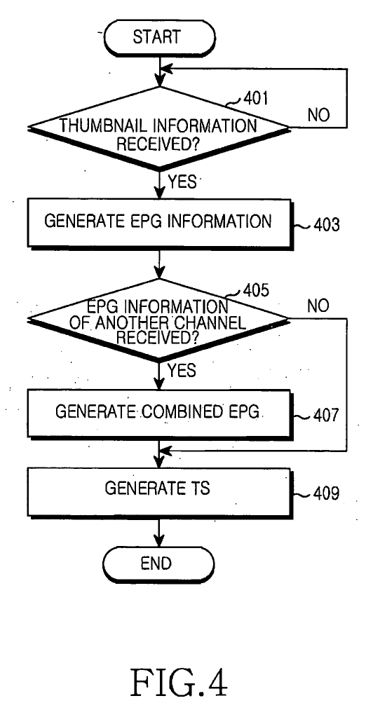

FIG. 4 is a flowchart illustrating a method for generating the combined EPG according to an exemplary embodiment of the present invention. In an exemplary implementation, it is assumed that the EPG server 301 transmits/receives the EPG information through the private line connected to the EPG server 321 for the transmitter of another channel.

Referring to FIG. 4, the EPG server 301 determines in step 401 whether the thumbnail information generated from the thumbnail information generator 303 is received. The thumbnail information represents the information for introducing the programs of the EPG service in a simple text or according to the characteristics of the programs. For example, the thumbnail information introduces news in a form of text, movies in a form of a preview moving picture or key moving picture, and a documentary in a form of an image.

When the thumbnail information of the self-channel is received, the EPG server 301 generates the EPG information of the self-channel by using the thumbnail information in step 403.

In step 405, the EPG server 301 determines whether the EPG information of another channel is received from the EPG server 321 for the transmitter of another channel. When the EPG information of another channel is not received, the EPG server 301 generates TS only using the EPG information of the self-channel in step 409. Then, the algorithm is terminated.

When the EPG information of another channel is received, the EPG server 301 combines the EPG information of the self-channel and the EPG information of another channel to generate the combined EPG information in step 407. In step 409, the EPG server 301 generates the TS using the combined EPG information. Then, the algorithm is terminated.

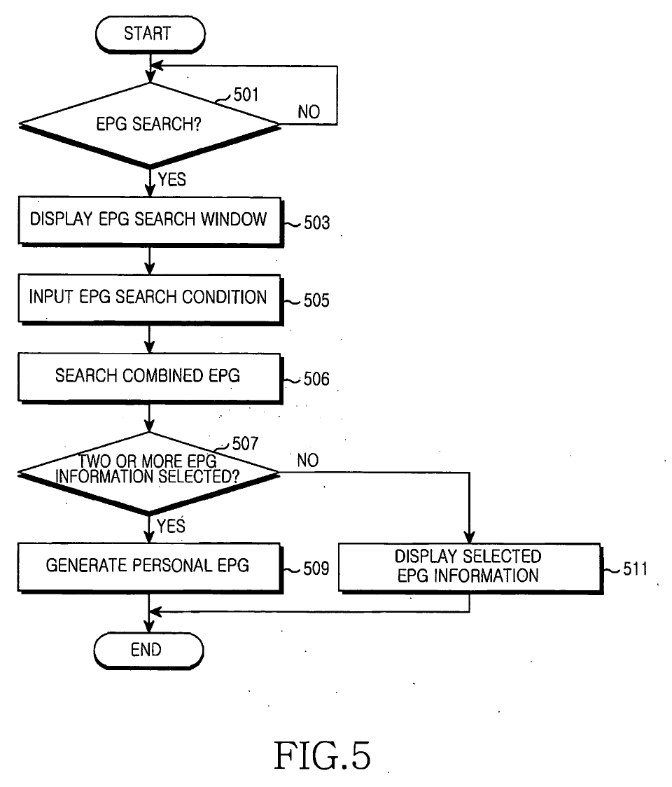

FIG. 5 is a flowchart illustrating a method for searching the EPG according to an exemplary embodiment of the present invention. Hereinafter, the method for generating the personal EPG in the terminal receiving the digital broadcasting will be described in detail.

Referring to FIG. 5, the terminal checks in step 501 whether the EPG search is performed by the user's key manipulation. When the EPG search is performed, the terminal displays an EPG search condition input window on a display window in step 503. That is, the search window is displayed to allow the user to input the search item (for example, genre, program name, broadcasting time, actor, director, and the like) and the search range (for example, program name, thumbnail information, and the like) for searching programs desired by the user.

When the search condition is inputted in the search condition input window by the user's key manipulation in step 505, the terminal searches the inputted search condition in the combined EPG in step 506.

In step 507, the terminal checks the number of the search results. When the number of the search results is less than two, the terminal displays the search results on the display window in step 511. Then, the algorithm is terminated.

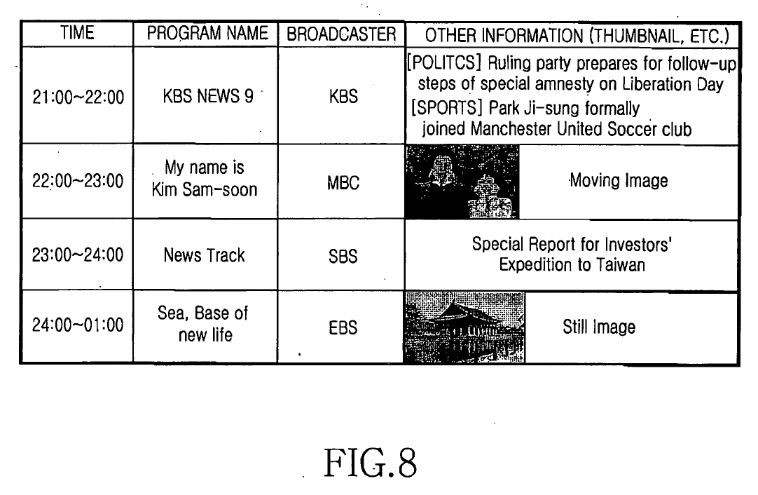

In step 509, when the number of the search results is equal to or more than two, the terminal generates the personal EPG of FIG. 8 by using the search results, allowing the user to easily check the desired program information. Then, the algorithm is terminated.

The generation of the personal EPG according to the plurality of search conditions has been described with reference to FIG. 5. According to an exemplary embodiment of the present invention, the user can generate the personal EPG by previously editing scheduled time and information of the user's favorite programs by using the EPG. The personal EPG is stored in the terminal, allowing the user to easily search favorite program information.

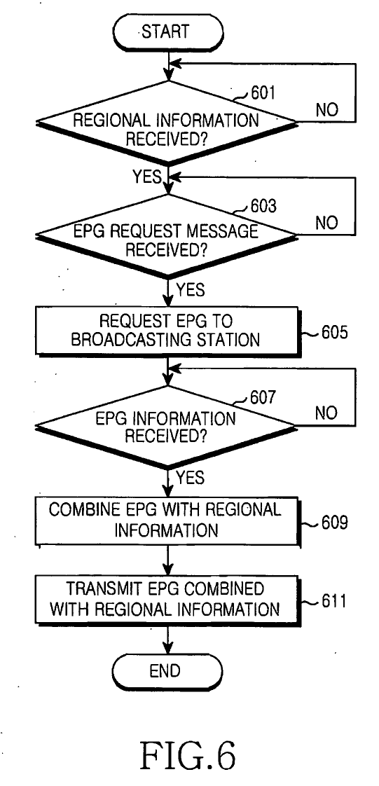

FIG. 6 is a flowchart illustrating a method for providing regional information using the EPG at a base station (gap filler) according to an exemplary embodiment of the present invention. The combination of the EPG and the regional information at the base station will be taken as an example, which can also be equally applied to the gap filler. The base station uses a mobile communication network to support bi-directional service in digital broadcasting that provides a uni-directional service. In addition, the gap filler is used to provide the digital broadcasting in a shadow area where the digital broadcasting signal is interrupted.

Referring to FIG. 6, the base station checks in step 601 whether regional information about shopping malls within the coverage of the base station, weather, shopping, and advertisement is received.

When the regional information is received, the base station determines whether the EPG information request message is received from the digital broadcasting receiver in step 603. When the EPG information request message is received, the terminal requests the EPG information to the digital broadcasting transmission center in step 605.

In step 607, the base station checks whether the EPG information is received from the transmission center. In step 609, when the EPG information is received from the transmission center, the base station adds the regional information (for example, the information about the shopping malls, weather, shopping, and advertisement) received in step 601 to a predetermined portion of the EPG information. That is, the EPG and the regional information are combined together.

In step 611, the base station transmits the EPG combined with the regional information to the terminal. Then, the algorithm is terminated.

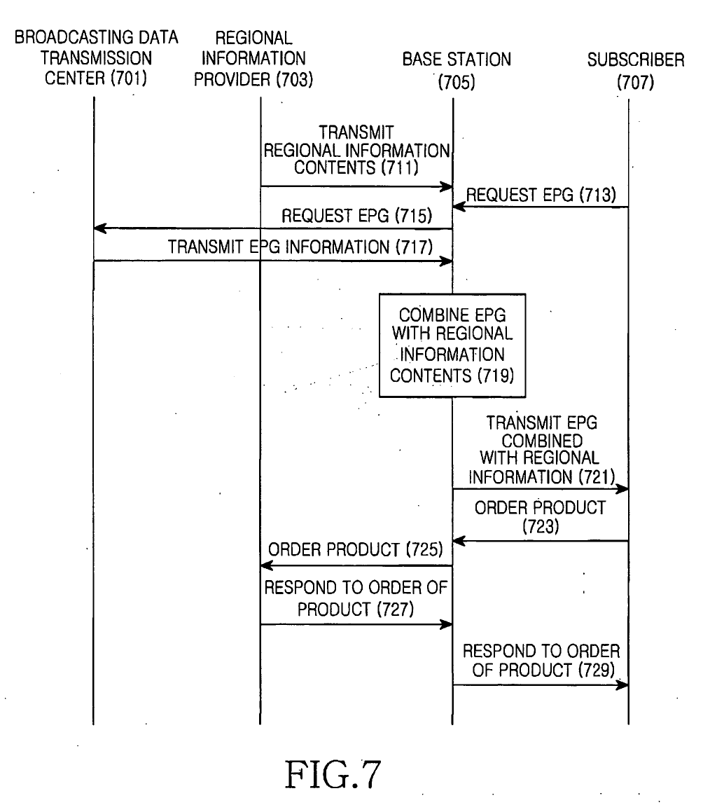

FIG. 7 is a flowchart illustrating a method for providing the regional information using the EPG according to an exemplary embodiment of the present invention. It is assumed that the shopping information among a variety of information is provided.

Referring to FIG. 7, a regional information provider 703 transmits the shopping information to the base station (gap filler) 705 in step 711, and the base station (gap filler) 705 stores the received shopping information.

In step 713, a digital broadcasting subscriber 707 transmits EPG request message to the base station (gap filler) 705 to check the program information. In step 715, the base station (gap filler) 705 requests the EPG to the broadcasting data transmission center 701 according to the EPG request of the subscriber 707.

In step 717, the broadcasting data transmission center 701 transmits the EPG information to the base station (gap filler) 705 according to the EPG request of the base station (gap filler) 705. In step 719, the base station (gap filler) 705 receiving the EPG information from the broadcasting data transmission center 701 combines the shopping information received from the regional information provider 703 with the EPG information. That is, the shopping information is inserted into a predetermined portion of the EPG information.

In step 721, the base station (gap filler) 705 transmits the EPG information combined with the shopping information to the subscriber 707, and the subscriber 707 checks the program information desired by the subscriber 707 by using the EPG information received from the base station (gap filler) 705.

When the subscriber 707 wants to purchase a specific product while viewing the shopping information contained in the EPG information, the subscriber 707 provides the product purchase intention to the regional information provider 703 through the base station (gap filler) 705 in steps 723 and 725.

The regional information provider 703 provides detailed information about the product desired by the subscriber 707 in step 727 or information about the purchase verification of the product to the subscriber 707 through the base station (gap filler) 705 in step 729.

FIG. 8 illustrates the personal EPG screen according to an exemplary embodiment of the present invention. As described above, the custom EPG dedicated to the subscriber can be configured to display the program broadcast time, program name, broadcaster, and other information (thumbnail information) according to the search procedure.

The EPG may be transmitted to other subscribers, so that it may be used according to their purposes.

As described above, the EPGs of the transmitters having different channels in the digital broadcasting system are connected through the private line, and the additional information such as the thumbnail information and the regional information is contained in the EPG and transmitted to the users. Therefore, the users can easily search the program information about other broadcasting channels without switching the channels. In addition, the quality of the EPG service can be improved. Moreover, the users can be allowed to personally configure the EPG, thereby providing the EPG according to the characteristics of the users.

While the invention has been shown and described with reference to certain exemplary embodiments thereof, it will be understood by those skilled in the art that various changes in form and details may be made therein without departing from the spirit and scope of the invention as defined by the appended claims and their equivalents.

What is claimed is:

1. An apparatus for providing electronic program guide (EPG) in a digital broadcasting system, the apparatus comprising:
an EPG connecting unit for connecting EPG servers of another digital broadcasting channel;
a program information generating unit for generating program information according to program characteristics of self digital broadcasting channel; and
an EPG server for generating EPG information using the generated program information, and combining the generated EPG information with EPG information of another broadcasting channel.

2. The apparatus of claim 1, wherein the program information generating unit generates the program information in a form of at least one of text, moving picture, and image according to characteristics of the respective programs.

3. The apparatus of claim 1, wherein the EPG connecting unit is connected to the EPG server of a different channel through a private line.

4. The apparatus of claim 1, wherein the EPG server generates EPG information of self-channel by using the program information generated from the program information generating unit, receives the EPG information of a different channel, and generates transport stream (TS) by combining the received EPG information with the EPG information of self-channel.

5. A method for generating combined EPG information in a digital broadcasting system, the method comprising:
generating EPG information of self-channel by using program information of the self-channel;
verifying whether EPG information of a different channel is received; and
combining the EPG information of the self-channel with the EPG information of the different channel, when the EPG information of the different channel is received.

6. The method of claim 5, wherein the program information is generated using at least one of text, moving picture, and image according to characteristics of the respective programs.

7. The method of claim 5, wherein the generating of the EPG comprises:
assigning identifier (ID) to the program information;
transmitting the program information over digital broadcasting data channel;
connecting the program information to the EPG using the ID of the program information.

8. The method of claim 5, further comprising generating TS by using the combined EPG information.

9. The method of claim 5, further comprising generating TS by using the EPG information of the self-channel, when the EPG information of the different channel is not received.

10. A method for generating personal EPG in a digital broadcasting system, the method comprising:
verifying whether EPG search condition is inputted in an EPG search mode;
searching the search condition from combined EPG information, when the EPG search condition is inputted;
verifying a number of the search results; and
generating a personal EPG, when the number of the search results is at least two.

11. The method of claim 10, wherein the combined EPG information is generated by combining EPG information of self-channel with EPG information of a different channel.

12. A method for operating a base station to provide regional information by using an EPG service in a digital broadcasting system, the method comprising:
requesting EPG to a broadcasting data transmission center, when an EPG request is received from a terminal;
verifying whether the requested EPG information is received; and
combining the EPG information with the regional information, when the requested EPG information is received.

13. The method of claim 12, wherein the regional information comprises at least one of information about shopping malls within a service coverage of the base station, weather information, and shopping information.

14. The method of claim 12, further comprising:
receiving the regional information from a regional information provider; and
storing the received regional information.

15. A method for operating a gap filler to provide regional information by using an EPG service in a digital broadcasting system, the method comprising:
requesting EPG to a broadcasting data transmission center, when an EPG request is received from a terminal;
verifying whether the requested EPG information is received; and
combining the EPG information with the regional information, when the requested EPG information is received.

16. The method of claim 15, wherein the regional information comprises at least one of information about shopping malls within a service coverage of the base station, weather information, and shopping information.

17. The method of claim 15, further comprising:
receiving the regional information from a regional information provider; and
storing the received regional information.

18. A method for providing regional information by using an EPG service in a digital broadcasting system, the method comprising:
transmitting regional information from a regional information provider to a base station, and transmitting an EPG request message from a terminal to the base station;
requesting the EPG from the base station to a broadcasting data transmission center according to the EPG request;
transmitting the EPG information from the broadcasting data transmission center to the base station according to the EPG request; and
receiving the EPG information and combining the EPG with the regional information at the base station, and transmitting the combined EPG to the terminal.

19. The method of claim 18, wherein the regional information comprises at least one of information about shopping malls within a service coverage of the base station, weather information, and shopping information.

20. The method of claim 18, further comprising storing the regional information received from the regional information provider in the base station.

21. A method for providing electronic program guide (EPG) and personal EPG in a digital broadcasting system, the method comprising:
connecting EPG servers of digital broadcasting channels;
generating program information according to program characteristics of the digital broadcasting channels;
generating EPG information using the generated program information, and combining the generated EPG information with EPG information of the broadcasting channels;
verifying whether EPG search condition is inputted in an EPG search mode;
searching the search condition from combined EPG information, when the EPG search condition is inputted;
verifying a number of the search results; and
generating a personal EPG, when the number of the search results is at least two.

22. The method of claim 21, wherein the EPG server generates EPG information of self-channel by using the program information generated from the program information generating unit, receives the EPG information of a different channel, and generates transport stream (TS) by combining the received EPG information with the EPG information of self-channel.

23. The method of claim 21, further comprising requesting the EPG to a broadcasting data transmission center, when an EPG request is received from a terminal.

24. The method of claim 23, further comprising verifying whether the requested EPG information is received.

25. The method of claim 24, further comprising combining the EPG information with regional information, when the requested EPG information is received.

26. The method of claim 25, wherein the regional information comprises at least one of information about shopping malls within a service coverage of the base station, weather information, and shopping information.

27. The method of claim 25, further comprising:
receiving the regional information from a regional information provider; and
storing the received regional information.

28. An apparatus for providing electronic program guide (EPG) in a digital broadcasting system, the apparatus comprising:
a program information generating unit for generating program information according to program characteristics of self digital broadcasting channel; and
an EPG server for receiving EPG information of another broadcasting channel and generating EPG information using the generated program information, and combining the generated EPG information with EPG information of another broadcasting channel.

29. The apparatus of claim 28, wherein the program information generating unit generates the program information in a form of at least one of text, moving picture, and image according to characteristics of the respective programs.
